(19) United States
(12) Patent Application Publication
(10) Pub. No.: US 2011/0257904 A1
(43) Pub. Date: Oct. 20, 2011

(54) MEASURING DEVICE

(75) Inventor: Ronald Arthur DENEAU, Gaithersburg, MD (US)

(73) Assignee: Hugging Mattress, Inc., Gaithersburg, MD (US)

(21) Appl. No.: 13/073,499

(22) Filed: Mar. 28, 2011

Related U.S. Application Data
(60) Provisional application No. 61/317,931, filed on Mar. 26, 2010.

(51) Int. Cl. G06F 19/00; G01L 5/00

(52) U.S. Cl. 702/41

(57) ABSTRACT

A method and device for measuring compression of a mattress includes a laser rangefinder and a weighted body. The weighted body may be placed onto a mattress surface and a measurement is taken before and after the mattress compresses under the weight. The difference between the two measurements is converted into an output indicative of the stiffness of the mattress. In an embodiment, the measuring device is embodied in a plush animal such as a bear.

### CROSS REFERENCE TO RELATED APPLICATIONS

This application claims the benefit of priority to U.S. Provisional Application Ser. No. 61/317,931, filed Mar. 26, 2010, the entire contents of which is incorporated herein in its entirety by reference.

### FIELD

The present invention relates generally to measuring a stiffness of a mattress and more particularly to measuring an induced deflection of the mattress when loaded with a weight.

### BACKGROUND

Mattresses have many different degrees of stiffness in order to accommodate a wide variety of users and their individual preferences. During mattress shopping, a customer may be informed by signage whether a particular mattress is generally soft or firm, but is not likely to receive quantitative information in this regard.

### SUMMARY

An aspect of an embodiment of the present invention includes a measuring device that determines a measurement of the deflection or compression of a mattress under a load, then provides a numerical output representative of the measured deflection.

An aspect of an embodiment of the present invention includes a method of measuring compression of a mattress under load including placing a weighted measuring device onto a top surface of the mattress and measuring a first distance to a stationary reference surface, allowing the weighted measuring device to compress the mattress and measuring a second distance to the stationary reference surface, using the measured first and second distances, determining an amount of compression of the mattress and providing an output representative of the determined compression.

### DESCRIPTION OF THE DRAWINGS

Other features described herein will be more readily apparent to those skilled in the art when reading the following detailed description in connection with the accompanying drawings, wherein:

FIGS. 1 is an illustration of a measuring device in accordance with an embodiment of the invention; and

FIG. 2 is a process diagram, illustrating a measurement process in accordance with an embodiment of the invention.

### DETAILED DESCRIPTION

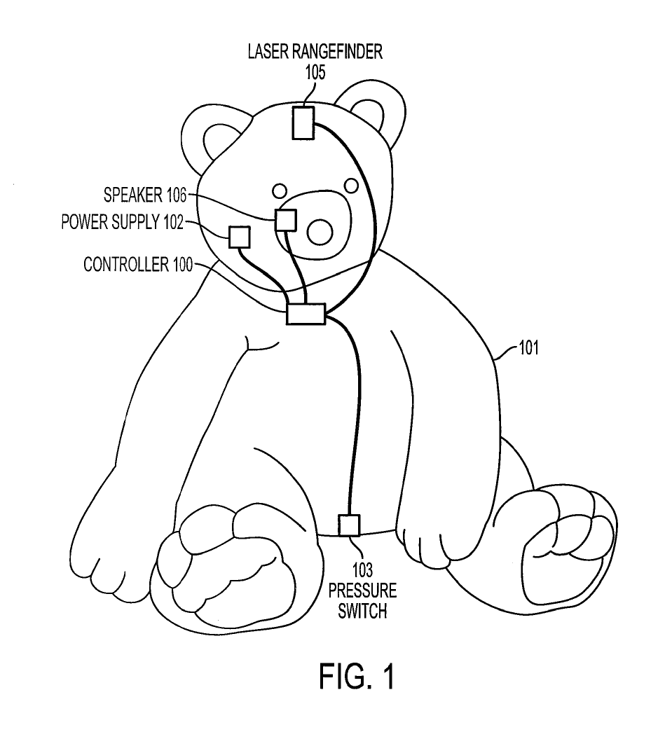

In an embodiment of the present invention as illustrated in FIG. 1, a measurement device includes a laser rangefinder 105 such as, for example, a Leica A6 laser rangefinder available from Leica Geosystems of St. Gallen, Switzerland. The laser rangefinder 105 is incorporated into a weighted body 101 which may be, in an embodiment, a plush toy such as a bear. The device further includes a pressure sensitive switch 103, a power supply 102 (such as a battery), a processor or computer controller 100 to control the laser rangefinder, and an output device such as a speaker 106. The switch 103 is in electronic communication with the controller 100, which is in turn in communication with the laser rangefinder 105, the speaker 106 and the power supply 102. As will be appreciated, electronic communication may include wired and/or wireless communication.

In an embodiment, the switch 103 may be a plunger-type switch. In a particular embodiment, the plunger may include a disk mounted in the bottom of the measuring device and attached to a plunger shaft that is slidably mounted within a sleeve. For example, an approximately 4″ dia., ⅛″ thick disk of aluminum or other material may be attached to a perpendicular ⅛″ diameter aluminum rod about 18″ high. The rod is mounted to slide up and down within a 5/16″ inner diameter tube. Gravity and a retainer pin in the rod hold the rod about 2 mm from making electrical contact with a small bus inside a dielectric housing for all the electronic systems. As the measuring device is lowered to the mattress, the disk is pushed up 2 mm, making the electrical contact that initiates operation as described in more detail below. As will be appreciated, other switches may be used in this role.

In an embodiment, the dimensions of the weighted body are selected to approximate a portion of human anatomy such as, for example, the hip. Likewise, the weight is selected to approximate an average load that the selected portion of human anatomy would place on the mattress. By way of example, the weighted body may be approximately 30 pounds and have an area of contact with the mattress of about 45 sq. in. In an embodiment, the weighted body may have an adjustable weight, for example by having removable weight modules, so that people of different builds may be modeled. In an embodiment, the weighted body is configured to exert between about 1 and about 2 pounds per square inch over a contact surface with the mattress. More particularly, the weighted body may be configured to exert about 1.5 pounds per square inch over the contact surface.

In an embodiment, the weighted body is of a size and shape such that it is relatively stable when placed onto a surface and such that the rangefinder is substantially vertically aligned when the weighted body is supported on the surface. In this regard, a relatively large base may be provided and the body should be sufficiently stiff to avoid slumping over.

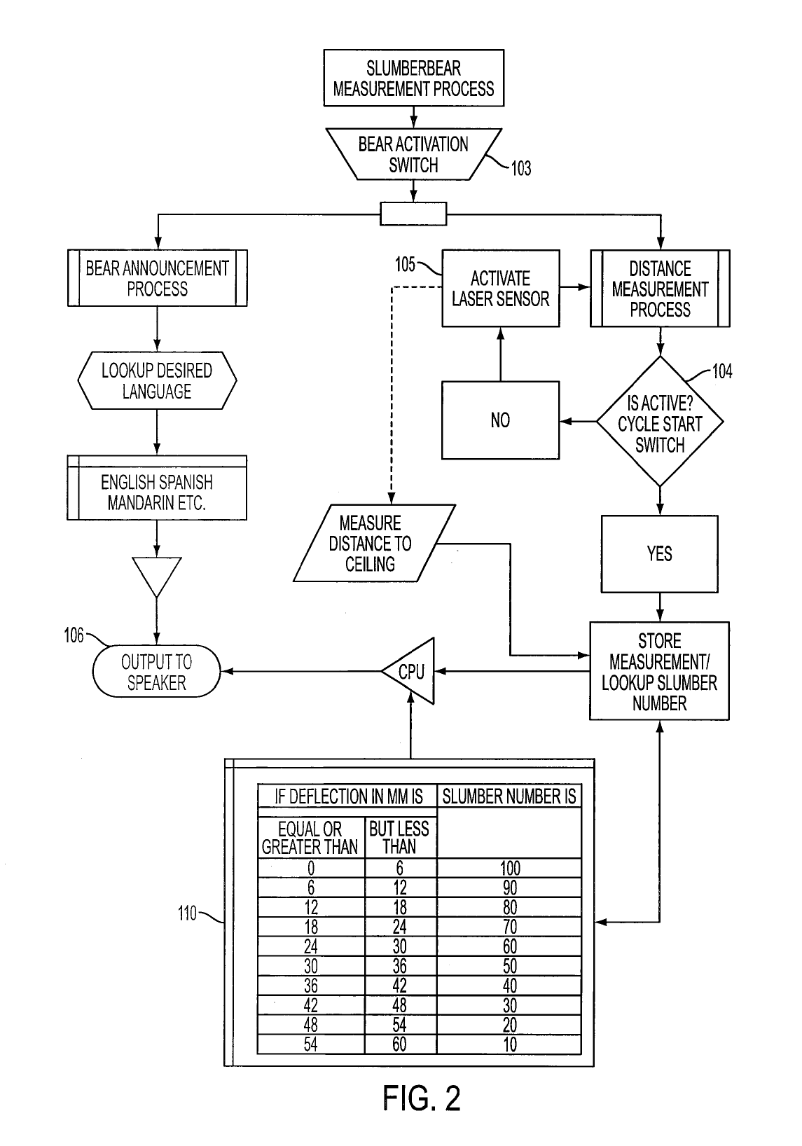

In operation as illustrated in FIG. 2, a pressure sensitive sensor 103 at the base of the weighted body 101 triggers a first distance measurement relative to a stationary reference surface, such as a ceiling of a mattress showroom. After a delay sufficient to allow for compression of the mattress, for example, about 1 second, a second measurement to the same reference surface is made. The difference between the two measurements represents the amount by which the mattress is compressed due to the weight of the measurement device. In an embodiment, the delay amount may be user-adjustable to account for slow deformation, as in a memory foam mattress or a mattress having a memory foam topper.

The measured compression is then output to a user. In an embodiment, the measured compression is converted, for example by use of a lookup table 110, into a numerical value. For example, a range of 1-10, 1-30, or 1-100 as illustrated in the FIG., may be assigned to various compression distances. Alternately, the range may begin with zero, or a qualitative label (e.g., soft, firm, firmest) may be provided instead of or in addition to the numerical value. In an embodiment, this number is output to the user by way of an audio signal which may include additional explanatory information.

In an embodiment, an announcement process may be initiated at the same time as the distance measurement process is initiated. This announcement process proceeds along the left hand side of the flow diagram of FIG. 2. In the announcement process, a language is optionally selected in accordance with a user setting. As will be appreciated, in addition to language, accent and/or dialect may be selectable in accordance with the locale in which the device is to be used. In general, the announcement may be selected from among a number of pre-recorded announcements. Alternately, a speech synthesis module may be employed to generate announcements. The announcement, incorporating the determined numerical value is then output to the speaker. Alternately or additionally, a visual display may be included.

In an embodiment, the device may incorporate additional available announcements that do not relate to the measuring function. For example, the device may be programmed to, at a user's request, or automatically in response to an initiation of the measurement cycle, output story content that may appeal to children such as the story of Goldilocks and the Three Bears.

In an embodiment, the device includes a reprogrammable memory and an input/output port that allows connection to a computing device for updates and/or additions to the library of available announcements and/or stories.

As will be appreciated, the same principles may be applied to other surfaces that undergo compression or deflection under a weight load. In particular, seats, including office chairs, auto and truck seats, lounge chairs, and mats such as gym mats and anti-fatigue/workstation mats may usefully be measured by a device of the disclosed type. The inventor has further determined that the device may find use in measurement of stiffness of nesting areas for poultry, the egg production of which can be affected by nest stiffness.

In an embodiment, a method of providing measuring services includes offering customers an opportunity to schedule a home visit in which a store employee brings a measuring device of the type described to measure the customers' current mattress. Alternately, the store may allow customers to check the measuring device out, take the measurement and return the device to the store. In this approach, a security deposit may be required in order to ensure that the device is returned. This service could be provided free or at a low cost, and in conjunction with sales materials relevant to new mattresses that are of a firmness similar to or different from the measured mattress.

Those skilled in the art will appreciate that the disclosed embodiments described herein are by way of example only, and that numerous variations will exist. For example, as will be appreciated by one of ordinary skill in the art, the dimensions described herein are by way of example, but are not limits as to sizes that may be used and aspects of various embodiments described may be combined. Likewise, the measuring device may be applicable to other types of furnishings such as couches and chairs, in addition to mattresses. The invention is limited only by the claims, which encompass the embodiments described herein as well as variants apparent to those skilled in the art.

I claim:

1. A measuring device for measuring firmness of a flexible surface comprising:
a distance measurement device;
a trigger, actuatable upon contact of the measuring device with the compressible surface to initiate a first measurement by the distance measurement device;
a delay, configured and arranged to delay initiation of a second measurement by a selected delay amount;
a processor, configured and arranged to determine a deflection or compression of the flexible surface by comparing the first and second distance measurements; and
an output device, configured and arranged to output information relating to the determined deflection or compression in a user-accessible manner.

2. A measuring device as in claim 1, wherein the measuring device is housed within a plush toy and wherein the trigger comprises a pressure actuatable switch that engages when the plush toy is placed on the surface.

3. A measuring device as in claim 1, wherein, when the surface is a surface of a furniture item, the processor is further configured to provide a number to the output device indicative of a firmness of the furniture item.

4. A measuring device as in claim 1, wherein, when the surface is a surface of a mattress, the processor is further configured to provide a number to the output device indicative of a firmness of the mattress.

5. A measuring device as in claim 1, wherein, when the surface is a surface of an egg-laying fowl nest, the processor is further configured to provide a number to the output device indicative of a stiffness of the egg-laying fowl nest.

6. A measuring device as in claim 1, wherein the output device comprises a speaker, and the user-accessible manner comprises audio.

7. A measuring device as in claim 6, wherein the audio is provided in accordance with a user-selectable manner.

8. A measuring device as in claim 7, wherein the user-selectable manner comprises a manner selected from the group consisting of: selectable language, selectable dialect and selectable accent.

9. A measuring device as in claim 1, further comprising:
a power supply, configured and arranged to provide power to the distance measuring device, the processor and the output device.

10. A measuring device as in claim 1, wherein the measuring device is constructed and arranged to have a weight and contact surface selected to produce a load of between about 1 and about 2 pounds per square inch over the contact surface of the measuring device.

11. A method of measuring firmness of a flexible surface comprising:
placing a measuring device onto the flexible surface, thereby actuating a trigger to initiate a first distance measurement prior to significant deformation of the flexible surface;
initiating a second distance measurement after a selected delay time;
determining a deflection or compression of the flexible surface by comparing the first and second distance measurements; and
outputting information relating to the determined deflection or compression to a user.

12. A method as in claim 11, wherein the measuring device is configured as a plush toy.

13. A method as in claim 11, wherein the measuring device exerts a force on the flexible surface of between about 1 and about 2 pounds per square inch.

14. A method as in claim 11, wherein the flexible surface is a surface of a furniture item, and the outputting comprises outputting a number indicative of a firmness of the furniture item.

15. A method as in claim 14, wherein the furniture item comprises a mattress.

16. A method as in claim 15, wherein the mattress is a customer's mattress and the method further comprises arranging a measurement of the customer's mattress in the customer's home.

17. A method as in claim 11, wherein the flexible surface is a surface of an egg-laying fowl nest.
